(19) United States
(12) Patent Application Publication
(10) Pub. No.: US 2021/0018122 A1
(43) Pub. Date: Jan. 21, 2021

(54) Advanced Coupling System

(71) Applicant: Darcy Leigh Beaumont, Stony Plain (CA)

(72) Inventor: Darcy Leigh Beaumont, Stony Plain (CA)

(21) Appl. No.: 16/882,834

(22) Filed: May 26, 2020

(30) Foreign Application Priority Data
May 27, 2019 (CA) 3044273

(51) Int. Cl. F16L 23/036; F16L 23/00

(52) U.S. Cl. CPC F16L 23/036; F16L 23/006

(57) ABSTRACT

An advanced coupling system that mechanically joins components such as pipe elements in an end to end configuration. Stiffening rings are fitted with grooves which receive sealing elements. A near zero gap exists at the joint. Coupling segments having different sized keys and angles connect any components together regardless of groove size, shape, dimension and angles. Monitoring of components is achieved. Accessories can be fitted between components being joined face to face. Attachments assist with the joining and separation of components and the installation of coupling segments.

### FIELD OF THE INVENTION

The invention concerns a mechanical coupling for joining components together such as pipe elements in an end-to-end configuration.

### BACKGROUND OF THE INVENTION

Couplings have been used for decades to join pipe elements in an end-to-end configuration. They differ from flange connections in that they are easier and quicker to install and typically require no welding. Flange connections on the other hand can have up to 28 studs and nuts on a 30″ flange which need to be carefully torqued in sequence and to spec. When flanges are over or under tightened they can leak at the joint. However, a coupling system typically eliminates this issue.

The mining sector is a large user of couplings as they typically have extensive piping networks which are low pressure. This makes couplings very attractive as they are easy to install and remove. Piping systems that transport slurries require continuous monitoring to ensure the integrity of the piping system. Couplings make the task of inspection easier and quicker as they can be removed and reinstalled quickly.

Piping systems in the mining industry that transport abrasive slurries are typically rotated a quarter turn after so many hours of operation. This is due to the wear which is mostly concentrated at the 6 o clock position of the piping system. Turning the pipe increases the life expectancy of the piping system and reduces the possibility of a catastrophic failure should the slurry wear completely through the piping system. To save time and resources, mining companies will rotate several pipes at the same time which are joined together.

Coupling systems come in a variety of sizes, shapes and configurations. Coupling systems are typically designed for a single application. The majority of coupling systems use a circumferential gasket. A gap exists between the faces of the piping elements so gas or liquids can energize the sealing element.

### SUMMARY OF THE INVENTION

An advanced coupling system that mechanically joins components such as pipe elements in end to end configuration. The advanced coupling system consists of a minimum of two coupling segments and two stiffening rings. Stiffening ring having a circumferential key groove proximate to an end thereof. The coupling segments having a pair of keys with a space between them and project radially inwardly. Large diameter coupling segments are fitted with a pair of stiffening ribs with a space between them projecting radially outwardly and align with said coupling segment keys. Stiffening rings with circumferential key grooves receive the coupling segment keys. Key surface angles and groove surface angles ranging from 0° to 45° relative to said plane. Coupling segment keys are forcibly engaged circumferentially around key grooves on the stiffening rings when the coupling segments are fitted around the stiffening rings and tightened resulting in a gap no larger than 3/16 and an ideal gap being 1/32 and smaller.

Stiffening rings are attached to components being joined in end to end configuration by means of welding, bonding, threading, bolting, casting or forging. A minimum of one groove which is positioned on the face of the stiffening ring facing the joint receives a sealing element which is mechanically anchored by means of mechanical compression, adhesion, pin and hole or any combination thereof. Said sealing element or elements provide the sealing and pressure containment.

Sealing elements consist of different shapes, sizes, materials and hardness. Sealing elements of different shapes, sizes, materials and hardness can be attached together. The sealing element partially or completely fills the groove. The sealing elements are energized by another sealing element or any surface rigid enough to adequately compress the sealing element. Sealing elements are removable, replaceable and interchangeable.

An advanced coupling system that mechanically joins components such as pipe elements in end to end configuration consisting of a minimum of two coupling segments and a minimum of one stiffening ring. Stiffening ring having a circumferential key groove proximate to an end thereof. Each coupling segment has a pair of keys projecting radially inwardly with a space between them. Each key having a different shape or size or key angles or any combination thereof. Key surface angles range from 0° to 45° relative to said plane. Large diameter coupling segments having a pair of stiffening ribs projecting radially outwardly with a space between them and substantially aligned with said coupling segment keys. Each coupling segment key for engagement with said circumferential key groove on stiffening rings, components or any combination thereof. Key grooves have surface angles ranging from 0° to 45° relative to said plane. The coupling segment keys are forcibly engaged circumferentially around key grooves and the key grooves receive the keys on the coupling segments when the coupling segments are fitted around the stiffening rings, components or any combination thereof. Stiffening rings are attached to components being joined in end to end configuration and are fitted with a minimum of one groove positioned on the face of the stiffening ring facing the joint which receives a sealing element which is mechanically anchored. Said sealing element or elements provide the sealing and pressure containment. The coupling segments having a different shape or size or key angles or any combination thereof will join any combination of components with or without a stiffening ring regardless of key groove size, shape, dimensions and groove angles.

Coupling segment keys offer several different camming surfaces that are identical or different and narrow said keys by as much as 85% on the inside faces of one or both keys at one or both ends and or in the middle of a coupling segment or any combination thereof having the same or different lengths of camming surfaces that occupy between 2.5% to 30% of the total arc length of said coupling key. Camming surfaces guide the coupling keys into key grooves when coupling segments are forcibly engaged circumferentially around the key grooves.

Camming surfaces are created with concaved or convexly curved surfaces relative to the surface of the keys.

Camming surfaces have an orientation angle between about 2° to about 20° relative to the respective key surfaces on which each camming surface is positioned.

Camming surface is formed of a flat surface portion and a concavely curved surface portion, the flat surface portions are substantially parallel to reference plans and offset from the inside key surfaces, the curved surface portions provide a smooth transition between the flat surface portions and the surfaces of the keys.

Camming surface is formed of a flat surface portion and an angularly oriented surface portion, the flat surface portions are substantially parallel to reference plans and offset from the inside key surfaces, the angularly oriented surface portions have an orientation angle relatively to the surfaces of the keys of 2° to about 45° are feasible, the angularly orientated surface portions provide a smooth transition between the flat, offset portions and the surfaces of the keys.

An advanced coupling system that mechanically joins components such as pipe elements in end to end configuration and capable of monitoring the components being joined in end to end configuration consisting of two coupling segments, a minimum of one stiffening ring and a minimum of one threaded hole exists to facilitate monitoring of the components being joined together. Each coupling segment having a pair of keys with a space between them which project radially inwardly. Each said coupling segment key for engagement with a circumferential key groove. Coupling segment keys are forcibly engaged circumferentially around key grooves and the key grooves receive the keys on the coupling segments. Coupling keys and key grooves have surface angles ranging from 0° to 45° relative to a reference plane.

A threaded hole is fitted to components such as coupling segments, stiffening rings, piping elements and accessories. A threaded hole extends from the outside diameter to the inside diameter or only partially extends from the outside diameter into a component such as a coupling segment, stiffening ring, piping element or accessory. Threaded holes which extend from the outside diameter to the inside diameter of one or more components with or without liners/coatings and accesses the pressure retaining space of a component is fitted with a bulk head connector/wire feedthrough. A threaded hole which only partially extends from the outside diameter into a component such as a coupling segment, stiffening ring, piping element or accessory is fitted with a monitoring device. The threaded hole facilitates permanent or temporary fitment of monitoring devices and bulk head connectors/wire feedthroughs and when permanently installed pressure containment is achieved.

An advanced coupling system that mechanically joins components such as pipe elements with or without liners/coatings in end to end configuration with accessories fitted between the faces of the components being joined in end to end configuration. The advanced coupling system consisting of a minimum of two coupling segments and accessories. Each coupling segment has a pair of keys with a space between them and projecting radially inwardly and having key surface angles ranging from 0° to 45° relative to said plane. Each coupling segment key for engagement with a circumferential key groove having key surface angles ranging from 0° to 45° relative to said plane. Coupling segment keys are forcibly engaged circumferentially around key grooves and key grooves receive the keys on the coupling segments.

The accessories consist of metallic, non-metallic or a combination of said materials.

The accessories include protective inserts and liner/coating anchors. The protective inserts and liner/coating anchors are fitted between two advanced coupling system stiffening rings or between one advanced coupling system stiffening ring and one stiffening ring of a different make and model or between components such as pipe elements, elbows, tees, crosses, Y bends, fittings, hoses, expansion joints, vessels, valves, tubes, flanges, tanks, filters, strainers, pumps, heat exchangers, reducers, steam traps, steam separators, instrumentation components or any combination thereof with one or no stiffening rings or between flanged connections.

Protective inserts and liner/coating anchors are fitted with or without holes on the faces or circumferential notches. The accessories vary in width and when fitted with one or more sealing elements create the seal between two components or flanged connections and regardless of configuration there shall be a gap no larger than 3/16 at any joint with an ideal gap being 1/32 and smaller.

Protective inserts and liner/coating anchors are fitted with or without a thread hole that continues from the outside diameter to the inside diameter or only partially extends from the outside diameter to the inside diameter. The threaded hole accommodates monitoring devices and bulk head connectors/wire feedthroughs. Protective inserts and liner/coating anchors come with or without liners/coatings. Non-metallic liners/coatings come with or without one or more monitoring device imbedded into the non-metallic material at different depths and positioned anywhere circumferentially.

The protective inserts consist of a ring or a ring and a re-enforced sub-straight ring, both versions of the protective inserts are lined/coated with a non-metallic or metallic material or any combination thereof. The protective insert with no re-enforced sub-straight ring has a liner/coating with an outside diameter the same or slightly smaller than the inside diameter of a component it is protecting. The re-enforced sub-straight ring has a smaller outside diameter than the inside diameter of the component it is protecting and is fitted with a minimum of one sealing element on the outside diameter of the re-enforced sub-straight ring or the sealing element is part of the liner/coating and both versions provide a snug fit between the protective insert re-enforced sub-straight ring and the inside diameter of the component it is protecting. All liners/coatings are bonded or mechanically anchored or any combination thereof to the protective inserts.

An advanced coupling system attachments assist with connecting and disconnecting of components being joined together in end to end configuration. The advanced coupling system attachments consist of a minimum of two segments, each segment having a minimum of one key projecting radially inwardly. Each segment key engages a circumferential key groove on components. The segment key is forcibly engaged circumferentially around the key groove and the key groove receives the key on the segments. Segments are joined together with a hinge.

The attachment for joining and disconnecting components consists of a minimum of two segments, a hinge, a connector and a key. The key projects radially inwardly and the segments are fitted over a component with or without a stiffening ring having a key groove. The segment key being forcibly engaged circumferentially around a key groove and the key groove receives the key on the segment. The connector locks the segments tightly around the component having a key groove. Each attachment segment has a minimum of one attachment point to accommodate the fitment of an expansion contraction device and allows articulation. The attachment attaches to all groove sizes, shapes and angles.

An attachment hinge is fitted to the bolt pads of two coupling segments. When these segments are suspended by a lifting sling connected to the lifting lugs closest to the attachment hinge the coupling segments will spread open enough to be dropped down over a component such as a pipe element without making contact with said component.

### SUMMARY OF THE DRAWINGS

FIG. 1 is a partial cutaway side view of the top of the advanced coupling system in end to end configuration consisting of a coupling segment with stiffening ribs and two stiffening rings with grooves on the faces. One groove receives a sealing element while the other groove receives a stiff sealing element. The stiff sealing element energizes the other sealing element. The stiffening rings have circumferential key grooves which receive one of the coupling segment keys. The stiffening rings are attached to components such as pipe elements, elbows, tees, crosses, Y bends, fittings, hoses, expansion joints, vessels, valves, tubes, flanges, tanks, filters, strainers, pumps, heat exchangers, reducers, steam traps, steam separators and instrumentation components and located at the ends or positioned so that end to end connections are achievable. A threaded hole is fitted to the coupling segment and only partially extends into the coupling. The threaded hole is fitted with a monitoring device. One stiffening ring is fitted with a threaded hole which partially extends into the ring and is fitted with a monitoring device. The other stiffening ring is fitted with a threaded hole which extends completely through the stiffening ring and is fitted a monitoring device. There is a near zero gap at the joint;

FIG. 2 is a partial cut away side view of the top of one optional stiffening ring which highlights the groove on the face which receives a sealing element. The groove has sides, a width and a depth. The size, shape and angles of the grooves can vary to accommodate a variety of sealing elements of various sizes and shapes. The sealing element is mechanically anchored by means of pins and holes. Sealing elements are removable, replaceable and interchangeable;

FIG. 3 is a partial cut away side view of the top of two stiffening rings with grooves on the faces. One groove is fitted with a sealing element and the other groove receives a stiff sealing element. The stiff sealing element energizes the other sealing element. Both sealing elements are mechanically anchored into the grooves by means of pins and holes and compression. The sealing elements are interchangeable;

FIG. 3A is a partial cut away side view of the top of two optional stiffening rings with grooves on the faces. One groove is fitted with two sealing elements attached together with pins and holes and only partially fills the groove. The other groove is fitted with a sealing element which is anchored in the groove by compression forces and the sealing element completely fills the groove. The sealing elements are interchangeable;

FIG. 3B is a partial cut away side view of the top of the two sealing elements shown in FIG. 3A which are attached together and anchored together by means of pins and holes;

Sealing elements consists of multiple sizes, shapes, dimensions, hardness and materials. Sealing elements of different shapes, sizes, materials and hardness can be attached together. A sealing element partially or completely fills a groove. The sealing element is energized by another sealing element or any surface rigid enough to adequately compress the sealing element, said sealing element is positioned by a minimum of one anchoring device.

FIG. 4 is a partial cut away side view of the top of a component such as a pipe element and a stiffening ring that is welded to a component such as a piping element with a but weld;

FIG. 4A is a partial cut away side view of the top of a component such as a pipe element and a stiffening ring that is friction welded to a component such as a pipe element;

FIG. 4B is a partial cut away side view of the top of a component such as a pipe element and a stiffening ring that is attached to a component such as a pipe element by means of threads;

FIG. 4C is a partial cut away side view of the top of a component such as a pipe element and a stiffening ring that is attached to a component such as a pipe element by means of bonding with adhesives;

FIG. 4D is a partial cut away side view of the top of a component such as a pipe element and a stiffening ring that is fillet welded to a component such as a pipe element;

FIG. 5 is a partial cut away side view of the top of a component such as a pipe element with stiffening rings attached to both ends. The stiffening rings have threaded holes which extend from the outside diameter to the inside diameter of the component such as a pipe element. The threaded holes are fitted with a bulk head connector/wire feedthroughs. The pipe has a non-metallic coating or liner with an embedded monitoring device such as conductive wire or fiber optic device. The conductive device or fiber optic device acts like a wear indication system;

FIG. 6 is a partial cutaway side view of the top of the advanced coupling system in end to end configuration consisting of a coupling segment, one advanced coupling system stiffening ring and a stiffening ring of a different make and model. The advanced coupling system stiffening ring is fitted with a groove on the face which receives a sealing element. The second stiffening ring is of a different make and model. The coupling keys are different. One coupling key size, shape and angle match the key groove on the stiffening ring of a different make and model. The stiffening ring of a different make and model is fitted with a threaded hole which extends completely through the stiffening ring and is fitted with a monitoring device. The rings are attached to the end of components such as pipe elements. The sealing element is energized by the firm surface of the stiffening ring of a different make and model. There is a near zero gap at the joint;

FIG. 7 is a partial cutaway side view of the top of the advanced coupling system in end to end configuration consisting of a coupling segment; two advanced coupling system stiffening rings and a protective insert. The coupling is fitted with a threaded hole which extends completely through the coupling and is fitted with a bulk head connector/wire feedthrough. The two advanced coupling system stiffening rings are fitted with grooves on the faces which receive sealing elements. A protective insert is positioned between the faces of the two stiffening rings and extends into the downstream component such as a piping element. The protective insert can also be fitted between flanged connections. The protective insert consists of a ring and a non-metallic liner. The ring must be firm enough to properly energize the sealing elements. The protective insert has a threaded hole to accommodate a bulk head connector/wire feedthrough device. A conductive wire or fiber optic device which acts as a wear indicator and is imbedded into the non-metallic liner. The protective insert is held in place due to a snug fit between the outside diameter of the protective insert that extends into the downstream component such as a piping element and the inside diameter of the component. The stiffening rings are attached to components such as pipe elements;

FIG. 7A is a partial cutaway side view of the top of a protective insert with grooves on each face which receive sealing elements. This protective insert will be positioned between two components such as piping elements or between flanged connections and creates the seal and provides a near zero gap joints. The width of the protective insert varies. The protective insert consists of a ring and a non-metallic liner. The ring must be firm enough to properly energize the sealing elements. The protective insert is fitted with a threaded hole to accommodate a bulk head connector/wire feedthrough device. A conductive wire or fiber optic device which acts as a wear indicator is imbedded into the non-metallic liner. The protective pipe liner is held in place due to a snug fit between the outside diameter of the protective pipe liner that extends into the downstream component such as a piping element and the inside diameter of the component;

FIG. 8 is a partial cutaway side view of the top of a protective insert. This protective insert will be positioned between two advanced coupling system stiffening rings, but can also be fitted between flanges. The protective insert consists of a ring and a re-enforced sub-straight ring which is fitted inside the downstream component such as a piping element. The rings must be firm enough to properly energize the sealing elements. The outside diameter of the re-enforced sub-straight ring is slightly smaller than the inside diameter of the component to deal with ovality issues. The ring and re-enforced sub-straight ring are lined with a non-metallic liner. However, a metallic coating can also be applied to the ring and re-enforced sub-straight ring. The protective insert is fitted with a threaded hole to accommodate a bulk head connector/wire feedthrough device. A conductive wire or fiber optic device which acts as a wear indicator is imbedded into the non-metallic liner or coating. Several conductive wires or fiber optic devices which act as wear indicators can be added to measure several different quadrants of the liner. A minimum of one sealing element is added to the outside of the re-enforced sub-straight ring at the end which is fitted into the component such as a piping element. Sealing elements provide a snug fit between the protective insert and the inside diameter of the component and also seal out containments;

FIG. 8A is a partial cutaway side view of the top of a protective insert with grooves on each face which receive sealing elements. This protective insert will be positioned between two components such as piping elements or between flanged connections and creates the seal and provides a near zero gap joints. This protective insert consists of a ring and a re-enforced sub-straight ring which is fitted inside the downstream component such as a piping element with or without a stiffening ring. The rings must be firm enough to properly energize the sealing elements. The outside diameter of the re-enforced sub-straight ring is slightly smaller than the inside diameter of the component such as a pipe element to deal with ovality issues. The ring and re-enforced sub-straight ring are lined with a non-metallic liner. However, a metallic coating can also be applied to the ring and re-enforced sub-straight ring. The protective insert is fitted with a threaded hole to accommodate a bulk head connector/wire feedthrough device. A conductive wire or fiber optic device which acts as a wear indicator is imbedded into the non-metallic liner or coating. Several conductive wires or fiber optic devices which act as wear indicators can be added to measure several different quadrants of the liner. A minimum of one sealing element is added to the outside of the re-enforced sub-straight ring at the end which is fitted into the component such as a piping element. A sealing element provides a snug fit between the protective insert and the inside diameter of the component and also seals out containments. The width of the protective insert varies;

FIG. 9 is a partial cutaway side view of the top of a protective insert. This protective insert is positioned between two advanced coupling system stiffening rings with grooves on the face fitted with sealing elements, but can also be fitted between flanged connections. This protective insert consists of a ring and a re-enforced sub-straight ring which is fitted inside the downstream component such as a piping element. The rings must be firm enough to properly energize the sealing elements. The outside diameter of the re-enforced sub-straight ring is slightly smaller than the inside diameter of the component such as a pipe element to deal with ovality issues. The ring and re-enforced sub-straight ring are lined with a non-metallic liner which extends around the edge of the re-enforced sub-straight ring forming a sealing element. The sealing element is beveled to assist with the installation of the protective insert. The outside diameter of the sealing element is greater than that of the re-enforced sub-straight ring so as to create a seal between the protective insert and the inside diameter of the component. The protective insert is fitted with a threaded hole to accommodate a bulk head connector/wire feedthrough device. A conductive wire or fiber optic device which acts as a wear indicator is imbedded into the non-metallic liner or coating. Several conductive wires or fiber optic devices which act as wear indicators can be added to measure several different quadrants of the liner. A metallic coating can also be applied to the ring and re-enforced sub-straight ring;

FIG. 9A is a front view of the protective insert shown in FIG. 9. Several conductive wires or fiber optic devices which act as wear indicators are embedded into the non-metallic liner/coating to monitor wear at several different quadrants of the liner/coating;

FIG. 10 shows the face of the ring for the optional protective insert shown in FIG. 8 and FIG. 9. Four threaded holes are added circumferentially around the ring. The threaded holes extend from the outside diameter of the ring to the inside diameter of the ring or extend only partially into the ring from the outside diameter. Threaded holes are added to the ring to accommodate monitoring devices and bulk head connector/wire feed through device. Anchoring holes can be added to the face of the ring. These anchoring holes enable the attachment of a rotation tool and can also be used for installation and removal. These anchoring holes can be added to protective inserts and liner/coating anchors. A minimum of four holes are added. Additional circumferential anchoring notches can be added to the circumferential edge so as to rotate protective inserts and liner/coating anchors without substantial separation of component ends;

FIG. 10A is a view taken from circle 10A in FIG. 10 showing the threaded hole which extends from the outside diameter all the way to the inside diameter and will be fitted with bulk head connector/wire feed through device;

FIG. 10B is a view taken from circle 10B in FIG. 10 showing the threaded hole which extends only partially into the ring from the outside diameter and will be fitted with a monitoring device;

FIG. 10C shows the top view of the ring with two threaded holes to accommodate monitoring devices and bulk head connector/wire feed through device. A circumferential anchoring notch is also shown;

FIG. 11 shows the face of the rotation tool which is mounted to the face of the ring in FIG. 10. A minimum of four holes are added so anchoring bolts can attach the rotation tool to the ring. The center of the rotation tool has an octagon hole to accommodate a breaker bar so as to rotate the ring;

FIG. 12 is a partial cutaway side view of the top of two components such as pipe elements joined end to end with flanges. The protective insert is fitted between the two flange faces. This protective insert consists of a ring and a re-enforced sub-straight ring which is fitted inside the downstream component such as a piping element. The outside diameter of the re-enforced sub-straight ring is slightly smaller than the inside diameter of the component such as a pipe element to deal with ovality issues. The ring and re-enforced sub-straight ring are lined with a non-metallic liner. However, a metallic coating can also be applied to the ring and re-enforced sub-straight ring. A minimum of one sealing element is added to the outside of the re-enforced sub-straight ring at the end which is fitted into the component. A sealing element provides a snug fit between the protective insert and the inside diameter of the component and also seals out containments. The protective insert is fitted with a threaded hole to accommodate a bulk head connector/wire feed through device. A conductive wire or fiber optic device which acts as a wear indicator is imbedded into the non-metallic liner or coating. Several conductive wires or fiber optic devices which act as wear indicators can be added to measure several different quadrants of the liner;

FIG. 13 is a partial cutaway side view of the top of the advanced coupling system in end to end configuration consisting of a coupling segment, one advanced coupling system stiffening ring, a component such as a pipe element and a protective insert. The coupling has two different keys. One component such as pipe element is fitted with an advanced coupling system stiffening ring which receives one of the keys on the coupling segment. The second component such as a pipe element does not have a stiffening ring and has a key groove that is cut or rolled into the component. One coupling key size, shape and angle matches the key groove on the stiffening ring and the other coupling key matches the key groove cut or rolled into the component such as a piping element. The coupling is fitted with a threaded hole which extends completely through the coupling and is fitted with bulk head connector/wire feedthrough. A protective insert is positioned between the stiffening ring and the downstream component such as a pipe element. The protective insert has a groove and sealing element on its face that faces the component such as a pipe element without the stiffening ring. The protective insert is fitted with a threaded hole to accommodate a bulk head connector/wire feed through device. A conductive wire or fiber optic device which acts as a wear indicator is imbedded into the non-metallic liner or coating. This configuration also allows for joining components such as piping elements of different outside dimensions and joining components with different sized, shaped, dimensional and angled key grooves;

FIG. 14 is a partial cutaway side view of the top of the advanced coupling system in end to end configuration consisting of a coupling segment and two components such as pipe elements. The coupling has no stiffening ribs and two identical keys and is fitted with a threaded hole which extents partially through the coupling and is fitted with a monitoring device. The key grooves on the components such as pipe elements are not fitted with stiffening rings and instead have cut or rolled key grooves which receive the coupling segment keys. One component such as a piping element is fitted with a threaded hole which is fitted with a bulk head connector/wire feedthrough. A conductive wire or fiber optic device is imbedded into the liner/coating on one component and acts as a wear indicator system. The two components and have a liner/coating. A circumferential sealing gasket is positioned around the joint;

FIG. 15 is a cut away side view of two advanced coupling system bolt on stiffening rings and the side view of a gate valve. The stiffening rings bolt to the faces of the gate valve allowing the gate valve to be attached to a component such as a piping element with the advanced coupling system. Protective inserts are fitted inside the bolt on stiffening rings and extend into the gate valve to the face of the gate;

FIG. 15A is a cut away side view of stiffening rings which are cast or forged into a component such as a gate valve. Protective inserts are fitted inside the stiffening rings and extend into the gate valve to the face of the gate;

FIG. 16 is a view of the coupling sections with keys, stiffening ribs, lifting lugs, perpendicular ribs, threaded holes and bolt pads with anchoring points for an attachment hinge or additional lifting lugs and caromed key surfaces;

FIG. 17 is a front view of the coupling segments which are hinged at one end and being supported by lifting slings. The coupling segments are opened by the forces exerted on the two sections from the lifting slings. This allows for easy installation of the coupling segments over components with or without stiffening rings;

FIG. 18 is a partial sectional view of a coupling segment illustrating the camming of the coupling keys;

FIG. 18A is a view taken from circle 18A in FIG. 18 showing the camming of the coupling keys on an enlarged scale;

FIG. 19 is a partial sectional view of a coupling segment illustrating the camming of the coupling keys;

FIG. 19A is a view taken from circle 19A in FIG. 19 showing the camming of the coupling keys on an enlarged scale;

FIG. 20 is a partial sectional view of a coupling segment illustrating the camming of the coupling keys;

FIG. 20A is a view taken from circle 20A in FIG. 20 showing the camming of the coupling keys on an enlarged scale;

FIG. 21 is a partial sectional view of a coupling segment illustrating the camming of the coupling keys;

FIG. 21A is a view taken from circle 21A in FIG. 21 showing the camming of the coupling keys on an enlarged scale;

FIG. 22 is a partial sectional view of a coupling segment illustrating the camming of the coupling keys;

FIG. 22A is a view taken from circle 22A in FIG. 22 showing the camming of the coupling keys on an enlarged scale;

FIG. 23 is a side view of two components such as pipe elements with advanced coupling system stiffening rings attached to the ends. An attachment consisting of a minimum of two segments having a minimum of one key is fitted and clamped over the stiffening ring having a key groove. The segment key is received by the circumferential key groove on the stiffening ring. Each attachment is fitted with a hinge and a connector. Each attachment segment has a minimum of one attachment point to accommodate the fitment of various devices such extension and contraction devices. A two way ram is shown in FIG. 23. FIG. 23 shows two attachments joined together with a two way ram. When a two way ram connects two attachments together; components such as pipe elements can be pulled together or pushed apart. The attachment allows for angular articulation enabling the two attachments to be connected together regardless of the misalignment of the two components such as pipe element ends. The attachment can also be used to install and remove protective inserts;

FIG. 23A is a front view of one attachment consisting of two segments each with a key, a hinge, a connector and one attachment point on each segment;

FIG. 24 is a partial cutaway side view of the top of the advanced coupling system in end to end configuration consisting of a coupling segment; two advanced coupling system stiffening rings and a liner/coating anchor. The two advanced coupling system stiffening rings are fitted with grooves on the faces which receive sealing elements. A threaded hole is fitted to the coupling and extends completely through the coupling. A liner/coating anchor is positioned between the faces of the stiffening rings but can also be fitted between flanges. The liner/coating anchor must be firm enough to energize the sealing elements. The liner/coating anchor is fitted with a threaded hole that partially extends into the liner/coating anchor and will receive a monitoring device. The liner/coating anchor assists in holding the liner or coating on both sides of the joint against the inside surface of the component such as a piping element;

FIG. 24A is a partial cutaway side view of the top of the advanced coupling system in end to end configuration consisting of a coupling segment, two advanced coupling system stiffening rings and a liner/coating anchor. The two stiffening rings are fitted with grooves on the faces which receive sealing elements. A threaded hole is fitted to the coupling and extends completely through the coupling. A liner/coating anchor is positioned between the faces of the stiffening rings but can also be fitted between flanged connections. The liner/coating anchor must be firm enough to energize the sealing elements. The liner/coating anchor is fitted with a threaded hole that partially extends into the liner/coating anchor and will receive a monitoring device. The liner/coating anchor assists in holding the liner or coating against the inside surface of the component such as a piping element downstream from the joint;

FIG. 25 is a partial cutaway side view of the top of the liner/coating anchor with grooves on each face which receives sealing elements which are mechanically anchored with holes and pins. This liner/coating anchor will be positioned between two components such as piping elements or between flanged connections and creates the seal and provides a near zero gap joints. The width of the liner/coating anchor varies. This version of the liner/coating anchor assists in holding the liner or coating on both sides of the joint against the inside surface of the component such as a piping element;

FIG. 25A is a partial cutaway side view of the top of the liner/coating anchor with grooves on each face which receives sealing elements which are mechanically anchored with holes and pins. This liner/coating anchor will be positioned between two components such as piping elements or between flanged connections and creates the seal and provides a near zero gap joints. The width of the liner/coating anchor varies. This version of the liner/coating anchor assists in holding the liner or coating downstream of the joint against the inside surface of the component such as a piping element;

Monitoring devices can be permanently installed or temporarily installed;

### DETAILED DESCRIPTION OF THE DRAWINGS

FIG. 1 is a partial cutaway side view of the top of the advanced coupling system in end to end configuration consisting of a coupling segment 18 and two stiffening rings 3A and 3B. The two stiffening rings 3A and 3B are attached to components 1A and 1B such as pipe elements. Stiffening rings can be attached to components such as pipe elements, elbows, tees, crosses, Y bends, fittings, hoses, expansion joints, vessels, valves, tubes, flanges, tanks, filters, strainers, pumps, heat exchangers, reducers, steam traps, steam separators, instrumentation components or any combination thereof together in an end to end configuration. The two components such as pipe elements 1A and 1B are joined in end to end configuration using mechanical coupling segment 18. Mechanical coupling 18 is fitted with a threaded hole 54 that partially extends into the coupling with is fitted with a monitoring device 53. The stiffening rings 3A and 3B are fitted face to face with a near zero gap between them. The stiffening rings 3A and 3B have circumferential key grooves 12A and 12B which receive the coupling keys 14A and 14B. The stiffening rings 3A and 3B surround the components such as pipe elements 1A and 1B and serve to add strength to the joint to address stresses imposed by bending, pressure and compression due to thermal expansion and lifting several pipes connected together.

The coupling segment 18 has a pair of keys 14A and 14B and a pair of stiffening ribs 16A and 16B. The keys 14A and 14B extend circumferentially around the coupling segment 18 and project radially inwardly towards the stiffening rings 3A and 3B. The stiffening ribs 16A and 16B extend circumferentially around the coupling segment 18 and project radially outwardly away from the stiffening rings 3A and 3B. The keys 14A and 14B are in spaced apart relation with a space there between 28. The ribs 16A and 16B are in spaced apart relation with a space there between 21; each rib is aligned with a respective key. It is advantageous to align the ribs with the keys to effectively strengthen and stiffen the coupling segments close to where the loads are applied by the components such as pipe elements to the coupling thereby maintaining maximum key engagement with the circumferential key grooves. Stiffening ribs are added to larger diameter couplings.

Circumferential key grooves 12A and 12B are positioned on the outside diameter of stiffening rings 3A and 3B which receive keys 14A and 14B of the coupling segment 18. It is advantageous to position the circumferential key grooves 12A and 12B in the rings rather than in components such as pipe elements 1A and 1B to avoid thinning of the components and thereby weakening the joint and the connection. The circumferential key grooves 12A and 12B have a complementary shape to the coupling keys 14A and 14B. Engagement of the keys within the grooves prevents thrust loads from separating the components such as pipe elements when they are under pressure. Preferably, the keys and key grooves are sized so that the keys fill the key grooves when the coupling segments are fastened together.

Stiffening ring 3B has a groove on the face 10 which receives a stiff sealing element 32. Stiffening ring 3A has a groove on the face 10 which receives a sealing element 5. Sealing element 32 energizes sealing element 5. Both sealing elements are removable, replaceable and interchangeable. The sealing elements are mechanically anchored.

Stiffening ring 3A is fitted with a threaded hole 54 which partially extends into the ring and is fitted with a monitoring device 53. Stiffening ring 3B is fitted with a threaded hole 54 which extends completely through the stiffening ring 3B and is fitted a monitoring device 53. The advanced coupling system coupling and stiffening rings consists of metallic or non-metallic materials. There is a near zero gap at the joint 2.

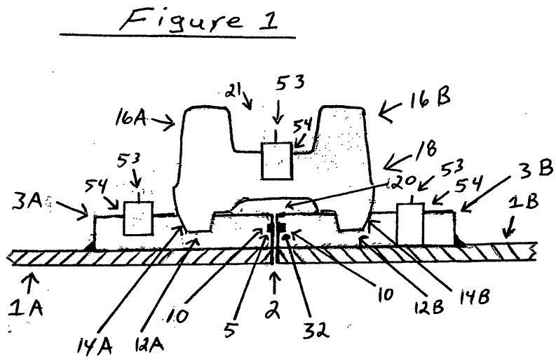

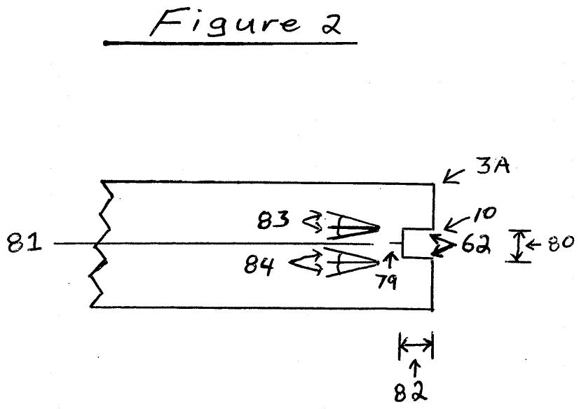

FIG. 2 is a partial cut away side view of the top of one stiffening ring 3A which highlights the groove 10 on the face which receives a sealing element. The groove consists of two sides 62, a width 80 and a depth 82. The size, shape and angles of the grooves can vary to accommodate a variety of sealing elements. Each side of the groove has an orientation angle 83 and 84 between 1° and 50° relative to an imaginary reference plane 81. The groove width 116 and depth 82 dimensions vary to accommodate sealing elements of various sizes and shapes. The sealing element is positioned and held in place by a minimum of one anchoring point such as a pin and hole 79. Any surface inside the groove can be used as an anchoring point.

Sealing elements are removable, replaceable and interchangeable.

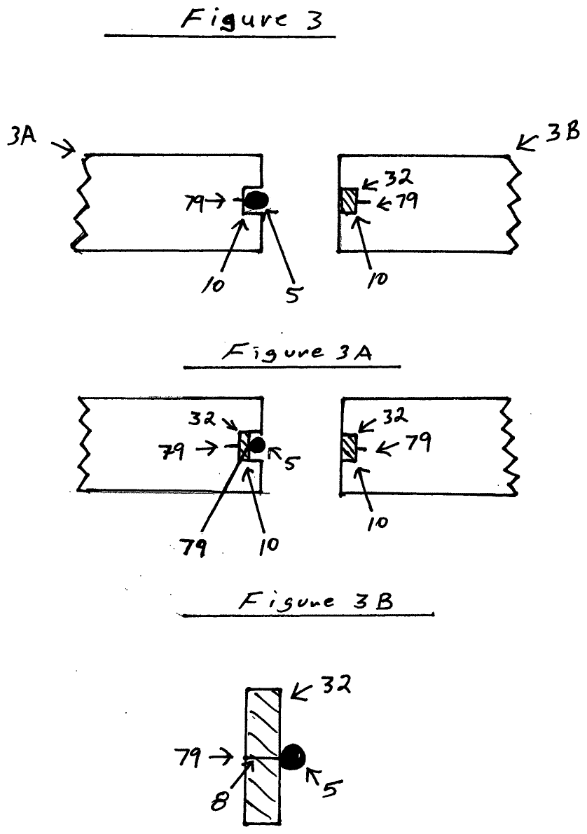

FIG. 3 is a partial cut away side view of the top of two advanced coupling system stiffening rings 3A and 3B with grooves 10 on the faces. Stiffening ring 3A is fitted with a sealing element 5 and stiffening ring 3B is fitted with a stiff sealing element 32. Both the sealing elements are mechanically anchored with a minimum of one anchoring pin and hole 79 that holds and positions the sealing elements within the grooves 10. The sealing elements are removable, replaceable and interchangeable. Sealing element 32 completely fills and seals the groove while sealing element 5 only partially fills the groove.

FIG. 3A is a partial cut away side view of the top of two advanced coupling system stiffening rings 3A and 3B with grooves 10 on the faces. Stiffening ring 3A is fitted with a sealing element 5 which is anchored to sealing element 32 with pins and holes 79 and sealing element 32 is anchored inside the groove by mechanical compression 4. Sealing element 5 and 32 only partially fill the groove on stiffening ring 3A. Stiffening ring 3B is fitted with sealing element 32 which is anchored inside the groove by mechanical compression 4 and completely fills the groove. The two sealing elements are interchangeable.

FIG. 3B is an enlarged partial cut away side view of the top side of the sealing element shown in FIG. 3A on stiffening ring 3A. Sealing element 5 is attached to sealing element 32 and anchored together by means of pins and holes 79. An adhesive 8 is also used to bond the two sealing elements together.

Sealing elements consists of multiple sizes, shapes, dimensions, hardness and materials. Sealing elements of different shapes, sizes, materials and hardness can be attached together. A sealing element partially or completely fills a groove. The sealing element is energized by another sealing element or any surface rigid enough to adequately compress the sealing element, said sealing element is positioned by a minimum of one anchoring device.

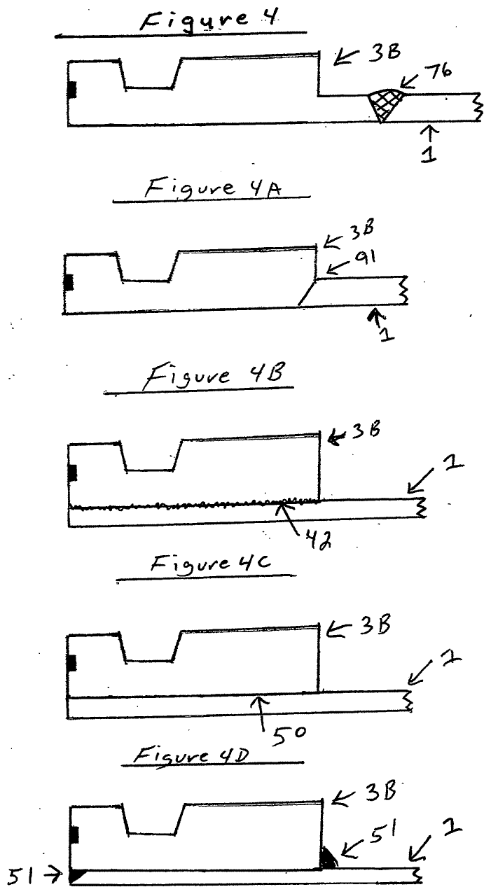

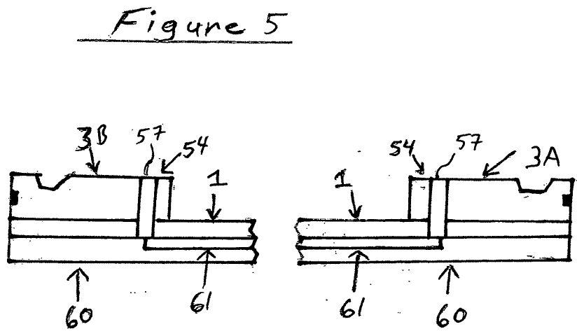

FIG. 4 is a partial cut away side view of the top of a component such as a pipe element 1 and a stiffening ring 3B that is welded to a component such as a piping element 1 with a but weld 76.

FIG. 4A is a partial cut away side view of the top of a component such as a pipe element 1 and a stiffening ring 3B that is friction welded 91 to a component such as a piping element 1.

FIG. 4B is a partial cut away side view of the top of a component such as a pipe element 1 and a stiffening ring 3B that is attached to a component such as a piping element 1 by means of threads 42.

FIG. 4C is a partial cut away side view of the top of a component such as a pipe element 1 and a stiffening ring 3B that is attached to a component such as a piping element 1 by means of bonding with adhesives 50.

FIG. 4D is a partial cut away side view of the top of a component 1 such as a pipe element and a stiffening ring 3B that is fillet welded 51 to a component such as a pipe element;

FIG. 5 is a partial cut away side view of the top of a component such as a pipe element 1 with stiffening rings 3A and 3B attached to both ends of the component such as a pipe element 1. Stiffening rings 3A and 3B have threaded holes 54 which extend to the inside diameter of the component 1. The threaded holes 54 are fitted with bulk head connectors/wire feedthroughs 57. The component such as a pipe element has a non-metallic coating or liner 60 attached to the inside diameter with an embedded conductive device or fiber optic device 61. The conductive device or fiber optic device 61 runs from one threaded hole on stiffening ring 3A which is fitted with bulk head connector/wire feedthrough 53 to the threaded hole 54 on stiffening ring 3B which is fitted with bulk head connector/wire feedthrough 53. The conductive device or fiber optic device 61 creates a wear indication system.

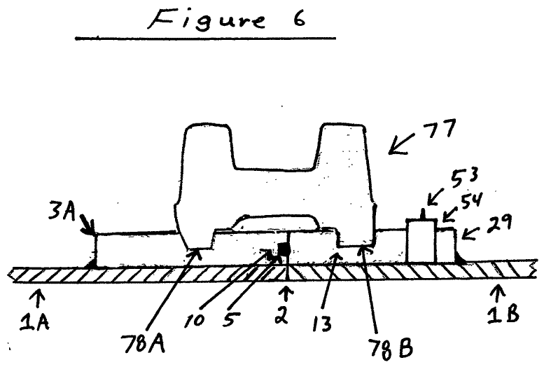

FIG. 6 is a partial cutaway side view of the top of the advanced coupling system in end to end configuration consisting of a coupling segment 77 which has two different keys. Stiffening ring 3A is attached to a component such as a pipe element 1A and a stiffening ring of a different make and model 29 is attached to a component such as a pipe element 1B. Stiffening ring 29 is fitted with a threaded hole 54 which extends completely through the stiffening ring 29 and is fitted with a monitoring device 53. The coupling keys 78A and 78B are different. The coupling key 78B size, shape and angle match the key groove 13 on the stiffening ring of a different make and model 29. The components 1A and 1B are joined end to end using mechanical coupling segment 77. Stiffening ring 3A and stiffening ring of a different make and model 29 are fitted face to face with a near zero gap between them 2. Stiffening ring 3A has a groove 10 on the inside face which receives a sealing element 5. The sealing element is energized by the firm surface of the stiffening ring of a different make and model 29.

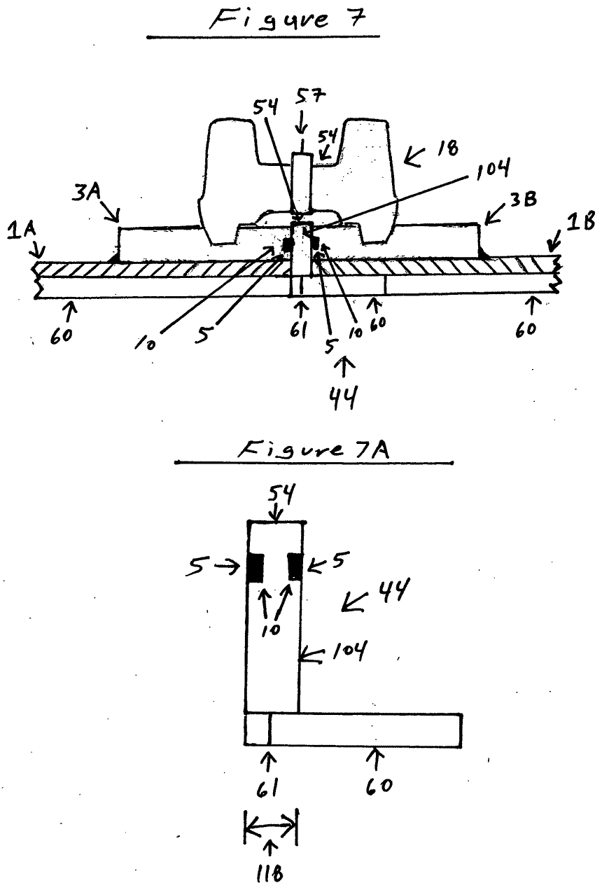

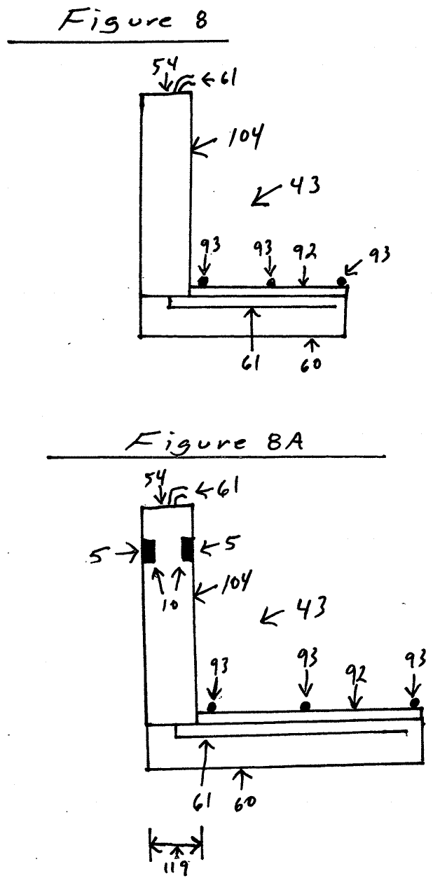

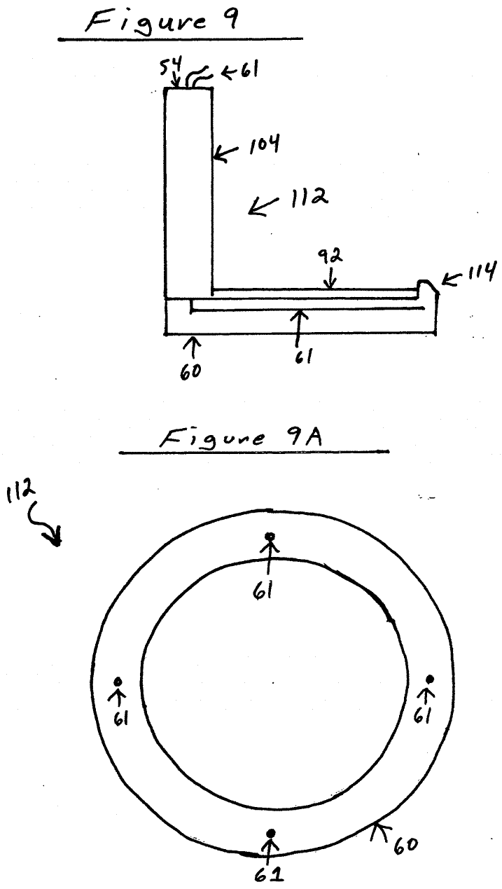

FIG. 7 is a partial cutaway side view of the top of the advanced coupling system in end to end configuration consisting of a coupling segment 18, stiffening rings 3A and 3B and a protective insert 44. Stiffening rings 3A and 3B are attached to components such as pipe elements 1A and 1B. The pair of components 1A and 1B is joined in end to end relation using mechanical coupling segment 18. The components 1A and 1B are lined with a non-metallic liner 60. However, the components 1A and 1B could also be coated with metallic coatings like chromium carbide or other similar erosion and corrosion resistant materials.

Stiffening rings 3A and 3B have grooves 10 on the faces which receive sealing elements 5. A protective insert 44 with no grooves or sealing elements is fitted between stiffening rings 3A and 3B but can also be fitted between flanged connections. The protective insert 44 consists of a ring 104 and a non-metallic liner 60. However, the liner could also be coated with a metallic coating. The coupling segment 18 is fitted with a threaded hole 54 which extends completely through the coupling and is fitted with a bulk head connector/wire feed through device 57. A threaded hole 54 which extends completely through the protective insert is added to the protective insert ring 104 to accommodate a bulk head connector/wire feed through device 57. The protective insert 44 is fitted into the downstream component such as a pipe element 1B and compression between the outside diameter of the protective insert 44 and the inside diameter of the component 1B hold the protective insert in position.

FIG. 7A is a partial cutaway side view of the top of an optional protective insert 44 with grooves 10 on both faces which receive sealing elements 5. The protective insert 44 is designed to be fitted between two components such as piping elements or between flanged connections and creates the seal and provides a near zero gap joints. The protective insert width 118 varies. The protective insert 44 consists of a ring 104 and a non-metallic liner 60. A threaded hole 54 which extends completely through the protective insert is added to the protective insert ring 104 to accommodate a bulk head connector/wire feed through device 57. The protective insert 44 is fitted into the downstream component such as a pipe element 1B and compression between the outside diameter of the protective insert 44 and the inside diameter of the component such as a piping element hold the protective insert in position.

FIG. 8 is a partial cutaway side view of the top of a protective insert 43 with no grooves or sealing elements. The protective insert 43 will be positioned between two stiffening rings with grooves and sealing elements and consists of a ring 104 and a non-metallic liner 60.

The protective insert 43 can also be fitted between flanged connections. The protective insert 43 utilizes a re-enforced sub-straight ring 92 which is fitted inside the component such as a piping element. A small clearance between the inside diameter of the component such as a piping element and the outside diameter of the re-enforced sub-straight ring 92 exists so as to address ovality issues. A non-metallic liner 60 is attached to the re-enforced sub-straight ring 92 and liner ring 104. However, a metallic coating can also be applied to the re-enforced sub-straight ring 92 and the liner ring 104. The re-enforced sub-straight ring 92 provides more rigidity of the liner which may be necessary with larger diameter protective inserts. A threaded hole 54 which extends completely through the protective insert is added to the protective insert ring 104 to accommodate bulk head connector/wire feed through device. A continuity wire or fiber optic device 61 is imbedded into the non-metallic liner 60 to act as a wear indicator. Several continuity devices or fiber optic devices 61 can be added to measure several different quadrants of the liner. A minimum of one sealing element 93 is added to the outside diameter of the re-enforced sub-straight 92 ring at the end which is fitted into the component such as a piping element. A sealing element 93 provides a snug fit between the re-enforced sub-straight ring 92 and the inside diameter of the component and also seals out containment.

FIG. 8A is a partial cutaway side view of the top of a protective insert with grooves 10 on both faces which receive sealing elements 5. The protective insert 43 is designed to be fitted between two components such as piping elements or between flanged connections and creates the seal and provides a near zero gap joint. The protective insert width 119 varies. The protective insert consists of a ring 104, a re-enforced sub-straight ring 92 and a non-metallic liner 60. The protective inset 43 utilizes a re-enforced sub-straight ring 92 which is fitted inside the component such as a piping element and allows for a small clearance between the inside diameter of the component and the outside diameter of the re-enforced sub-straight ring to address ovality issues. A non-metallic liner 60 is attached to the re-enforced stub-straight ring 92 and the liner ring 104. However, a metallic coating can also be applied to the re-enforced sub-straight ring 92 and the liner ring 104. The re-enforced sub-straight ring provides more rigidity of the liner which may be necessary with larger diameter protective inserts. A threaded hole 54 which extends completely through the protective insert is added to the protective pipe liner ring 104 to accommodate a bulk head connector/wire feed through device. A continuity wire or fiber optic device 61 is imbedded into the non-metallic liner 60 to act as a wear indicator. Several continuity wires or fiber optic devices can be added to measure several different quadrants of the liner. A minimum of one sealing element 93 is added to the outside diameter of the re-enforced sub-straight ring 92 at the end which is fitted into the component. A sealing element 93 provides a snug fit between the re-enforced sub-straight ring 92 and the inside diameter of the component and also seals out containment.

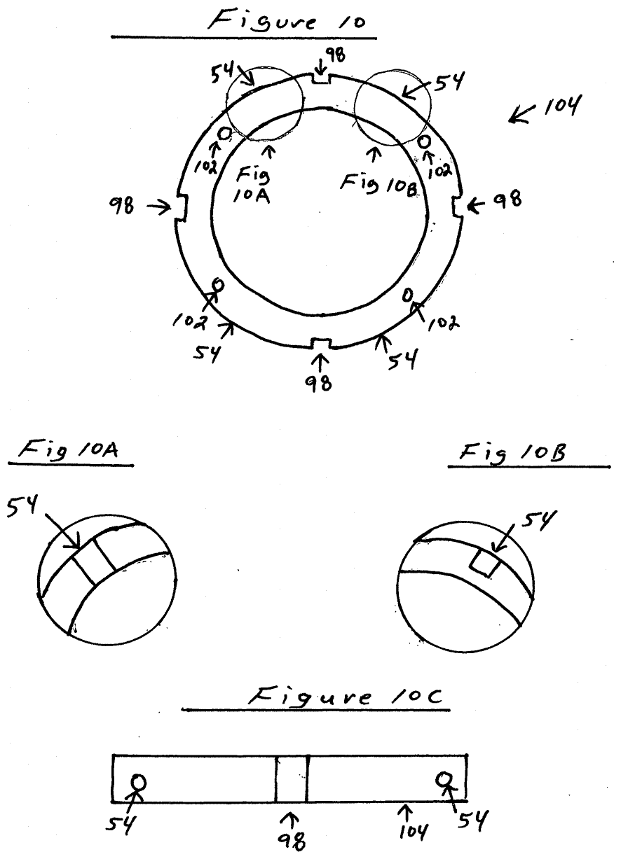

FIG. 9 is a partial cutaway side view of the top of a protective pipe liner 112 with no grooves or sealing elements and having a beveled sealing element for easier installation. This protective insert 112 will be positioned between two stiffening rings with grooves and sealing elements. The protective pipe liner 112 can also be fitted between flanged connections. This protective pipe liner consists of a ring 104 and a re-enforced sub-straight ring 92 which is fitted inside the downstream of a component such as a piping element. The ring must be firm enough to properly energize any sealing elements. The outside diameter of the re-enforced sub-straight ring 92 is slightly smaller than the inside diameter of the component such as a pipe element to deal with ovality issues. The ring and re-enforced sub-straight ring are lined with a non-metallic liner 60 which extends around the edge of the re-enforced sub-straight ring 92 forming a sealing element with a beveled edge 114. The sealing element is beveled to assist with the installation of the protective insert 112. The outside diameter of the sealing element 114 is greater than that of the re-enforced sub-straight ring 92 so as to create a seal between the protective insert 112 and the inside diameter of the component. A metallic coating can also be applied to the ring 104 and re-enforced sub-straight ring 92. A threaded hole 54 which extends completely through the protective insert is added to the protective insert ring 104 to accommodate a bulk head connector/wire feed through device. A continuity wire or fiber optic device 61 is embedded into the non-metallic liner 60 to act as a wear indicator. Several continuity wires or fiber optic devices 61 can be added to measure several different quadrants of the liner.

FIG. 9A is a front view of the protective insert 112 shown in FIG. 9. Several conductive wires or fiber optic devices 61 which act as wear indicators are embedded into the non-metallic liner/coating 60 to monitor wear at several different quadrants of the liner/coating 60.

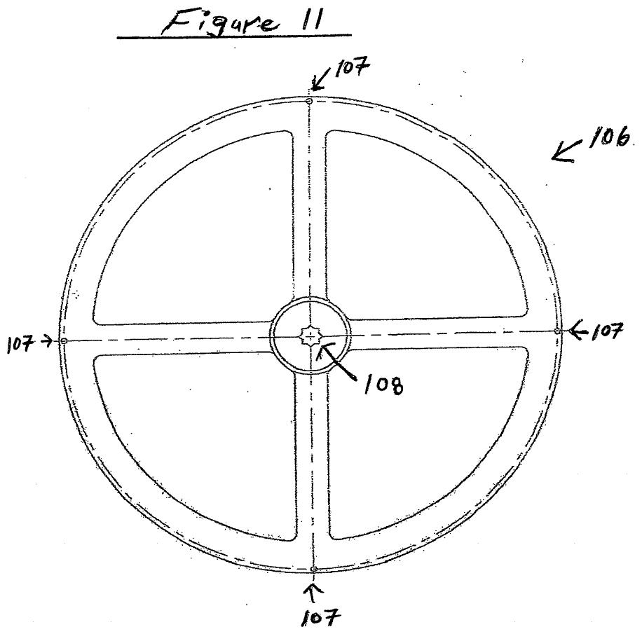

FIG. 10 shows the face of the ring 104 for the protective insert 43 shown in FIG. 8 and FIG. 9. Four threaded holes 54 are added circumferentially around the ring 104. These threaded holes 54 extend from the outside diameter of the ring 104 to the inside diameter of the ring 104 or extend only partially into the ring from the outside diameter. Threaded holes 54 are added to the ring 104 to accommodate monitoring devices and bulk head connectors/wire feedthroughs. Threaded holes 54 can be added to protective inserts and liner/coating anchors. Anchoring holes 102 are added to the face of the ring 104. These anchoring holes 102 enable the attachment of a rotation tool and can also be used for installation and removal. These anchoring holes can be added to protective inserts and liner/coating anchors. A minimum of four anchoring holes are added. Additional circumferential anchoring notches 98 can be added to the circumferential edge so as to rotate protective inserts and liner/coating anchors without substantial separation of the components being joined together end to end.

FIG. 10A is a view taken from circle 10A in FIG. 10 showing the threaded hole 54 which extends from the outside diameter all the way to the inside diameter of the ring 104 and will be fitted with a bulk head connector/wire feedthrough.

FIG. 10B is a view taken from circle 10B in FIG. 10 showing the threaded hole 54 which extends only partially into the ring from the outside diameter and will be fitted with a monitoring device.

FIG. 10C shows the top view of the ring 104 with two threaded holes 54 to accommodate monitoring devices or bulk head connectors/wire feedthroughs. Circumferential anchoring notch is also shown 98.

Holes 102 are can be added to the face of protective inserts and liner/coating anchors to provide anchoring holes to mount a rotation tool or to assist with installation or removal.

FIG. 11 shows the face of the rotation tool 106 which is mounted to the face of the ring in FIG. 10. A minimum of four holes 107 are added so anchoring bolts can attach the rotation tool 106 to the anchoring holes on the ring. The center of the rotation tool has an octagon hole 108 to accommodate a breaker bar so as to rotate the ring and ultimately the protective insert and liner/coating anchor. Erosion is mostly concentrated at the bottom of piping systems so rotation is essential.

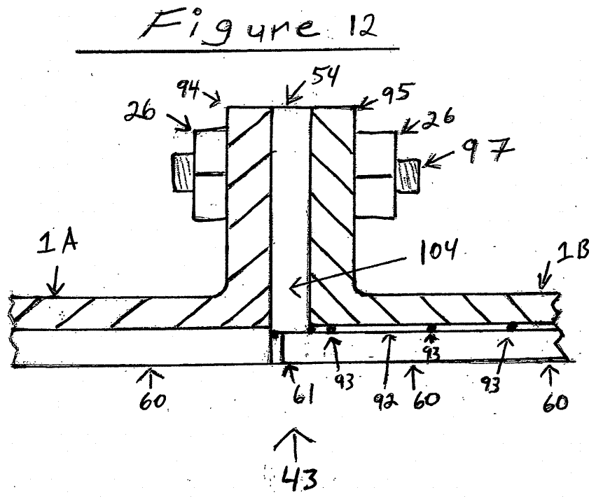

FIG. 12 is a partial cutaway side view of the top of two components such as pipe elements 1A and 1B which are joined end to end with flanges 94 and 95. A protective insert 43 with no grooves or sealing elements consisting of a ring 104 and a re-enforcing sub-straight ring 92 is fitted between the flange faces and lined with a non-metallic liner 60. A stud 97 and two nuts 26 connect the two flanges together and compress the protective insert 43 between the two flange faces. The protective insert and the components 1A and 1B are lined with a non-metallic liner 60. A threaded hole 54 which extends completely through the protective insert is added to the ring 104 to accommodate a bulk head connector/wire feedthrough. A conductive wire or fiber optic device 61 is imbedded into the non-metallic liner and the continuity wire or fiber optic device 61 acts as a wear indicator. Several continuity wires or fiber optic devices can be added to measure several different quadrants of the liner. A metallic coating can also be applied to the re-enforced sub-straight ring 92 and the liner ring 104. The re-enforced sub-straight ring 92 provides more rigidity of the liner which may be necessary with larger diameter protective inserts 43. A minimum of one sealing element 93 is added to the outside of the re-enforced sub-straight ring at the end which is fitted into the component. A sealing element provides a snug fit between the protective insert and the inside diameter of the component such as a piping element and also seals out contaminants.

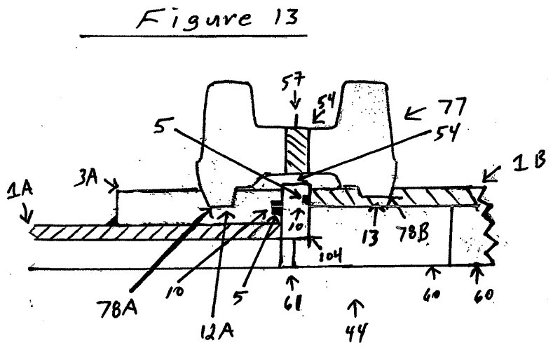

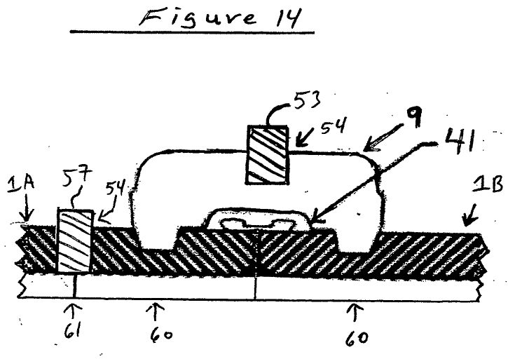

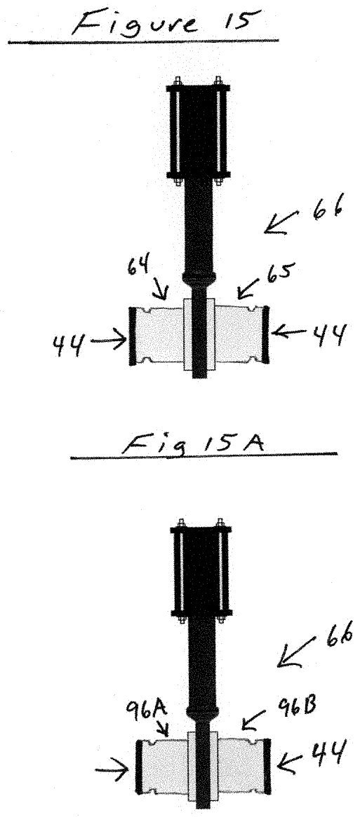

FIG. 13 is a partial cutaway side view of the top of the advanced coupling system in end to end configuration consisting of a coupling segment 77, stiffening ring 3A, a component such as a pipe element 1A and 1B and a protective insert 44. The coupling has two different keys 78A and 78B. A component such as a pipe element 1A is fitted with stiffening ring 3A. The key groove 12A on stiffening ring 3A receives coupling key 78A on the coupling segment 77. The second component 1B such as a pipe element does not have a stiffening ring. The key groove 13 on component 1B are cut or rolled into the component. Coupling key 78A matches the size, shape and angle of the key groove 12A on the stiffening ring 3A. Coupling key 78B matches the size, shape and angle of the key groove 13 on component 1B. Components 1A and 1B are joined in end to end relation using mechanical coupling segment 77. Coupling 77 is fitted with a threaded hole 54 which extends completely through the coupling 77 and is fitted with a bulk head connector/wire feedthrough 57. Stiffening ring 3A has a groove on the face 10 that receives a sealing element 5. A protective insert 43 consisting of a ring 104 and a non-metallic liner 60 is fitted between the two components 1A and 1B. The protective insert is fitted with a threaded hole 54 which extends completely through the protective insert and is fitted with a bulk head connector/wire feedthrough. A conductive wire or fiber optic device 61 is imbedded into the non-metallic liner and the continuity wire or fiber optic device 61 acts as a wear indicator. The protective insert 43 has a groove 10 on the face towards component 1B which is fitted with a sealing element 5. This configuration also allows for joining of components such as pipe elements with different outside dimensions.

Liners and coatings can be bonded or mechanically anchored to all rings and re-enforcing sub-straight rings or any combination thereof.

FIG. 14 is a partial cutaway side view of the top of the advanced coupling system in end to end configuration consisting of a coupling segment 9 and two components such as pipe elements 1A and 1B. The coupling has no stiffening ribs and two identical keys 49A and 49B and is fitted with a threaded hole 54 which extents partially through the coupling and is fitted with a monitoring device 53. The key grooves on components 1A and 1B such as pipe elements are not fitted with stiffening rings and instead have cut or rolled key grooves which receive the coupling segment keys 49A and 49B. The component 1A such as a piping element is fitted with a threaded hole 54 which extends completely through to the inside of the component 1A and is fitted with a bulk head connector/wire feed through 57. A conductive wire or fiber optic device 61 is imbedded into the liner/coating 60 on component 1A and acts as a wear indicator system. The two components 1A and 1B have a liner/coating 60. A circumferential sealing gasket is positioned around the joint 41.

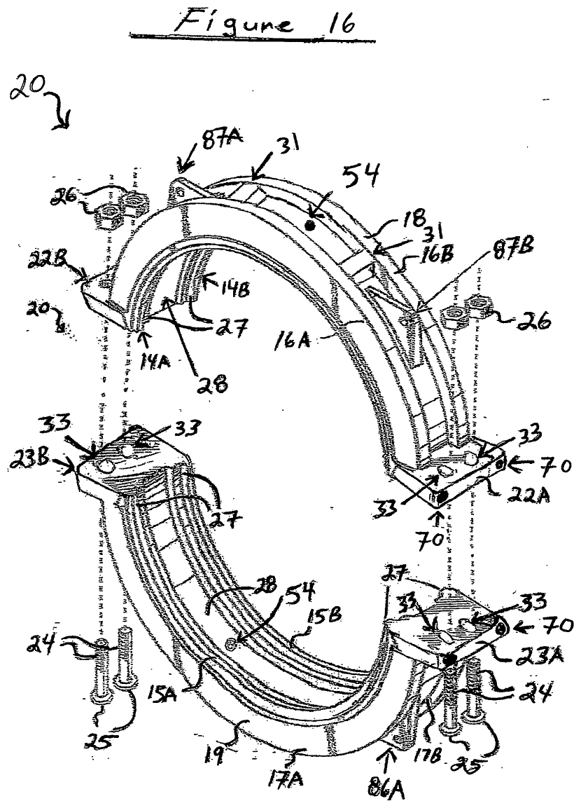

FIG. 15 is a cut away side view of two optional bolt-on stiffening rings 64 and 65 and a side view of a gate valve 66. The stiffening rings 64 and 65 bolt to the faces of the gate valve 66 allowing the gate valve to be attached to a piping element using the advanced coupling system. Protective inserts 44 are fitted inside the bolt on stiffening rings 64 and 65 and extend into the gate valve to the face of the gate.

FIG. 15A is a cut away side view of stiffening rings 96A and 96B which are cast or forged into a component such as a gate valve 66. Protective inserts 44 are fitted inside the stiffening rings and extend into the gate valve to the face of the gate.

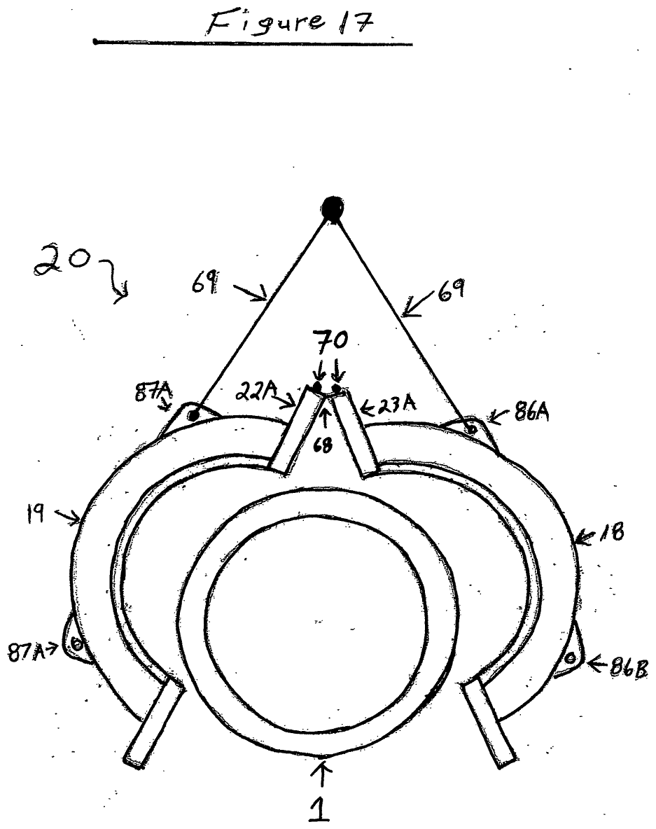

FIG. 16 shows a complete coupling 20 consisting of two coupling segments 18 and 19. As shown in FIG. 16 the camming surfaces 27 face inwardly toward the space 28 between the keys. Each camming surface 27 is defined by a thinning of the keys 14A, 14B, 15A and 15B. Camming surfaces can be identical or different and narrow the keys by as much as 85% on the inside faces of one or both keys, at one or both ends and or in the middle of a coupling segment or any combination thereof having the same or different lengths of camming surfaces that occupy between 2.5% to 30% of the total arc length of the coupling key. Camming surfaces guide the coupling keys into key grooves when said coupling segments are forcibly engaged circumferentially around key grooves on components such as pipe elements, stiffening rings, elbows, tees, crosses, Y bends, fittings, hoses, expansion joints, vessels, valves, tubes, flanges, tanks, filters, strainers, pumps, heat exchangers, reduces, steam traps, steam separators, instrumentation components or any combination thereof. Two ribs 16A and 16B are included as part of coupling segment 18 and project radially outwardly away therefrom and are positioned above the keys 14A and 14B and provide additional strength to the coupling and ultimately the joint and are only fitted to large coupling segments. Two perpendicular ribs 31 are located on coupling 18 and add additional strength to the coupling segment. Two ribs 17A and 17B are included as part of coupling segment 19 and project radially outwardly away therefrom and are positioned above the keys 15A and 15B and provide additional strength to the coupling and ultimately the joint and are only fitted to large coupling segments. Threaded holes 54 are shown on coupling segment 18 and 19. Lifting lugs 86A and 86B are located on coupling segment 19 and located close to the bolt pads. Lifting lugs 87A and 87B are located on coupling segment 18 and located close to the bolt pads. Bolt pads 22A and 22B are included as part of coupling segment 18 and include 2 oval holes 33 to accommodate bolts 25. Bolt pads 23A and 232B are included as part of coupling segment 19 and include 2 oval holes 33 to accommodate bolts 25. Bolt pads 22A, 22B, 23A and 23B have anchoring points 70 to accommodate the fitment of an attachment hinge and additional lifting lugs. Bolts 25 with fasteners 26 are fitted through the oval holes 33 on the bolt pads 23A, 23B, 22A and 22B. Nuts 26 are fitted to the bolts 25 and engage the fasteners 26 to tighten the two couplings 18 and 19 together until bolt pads 22A, 23A and 22B and 23B meet together with little or no gap between them.

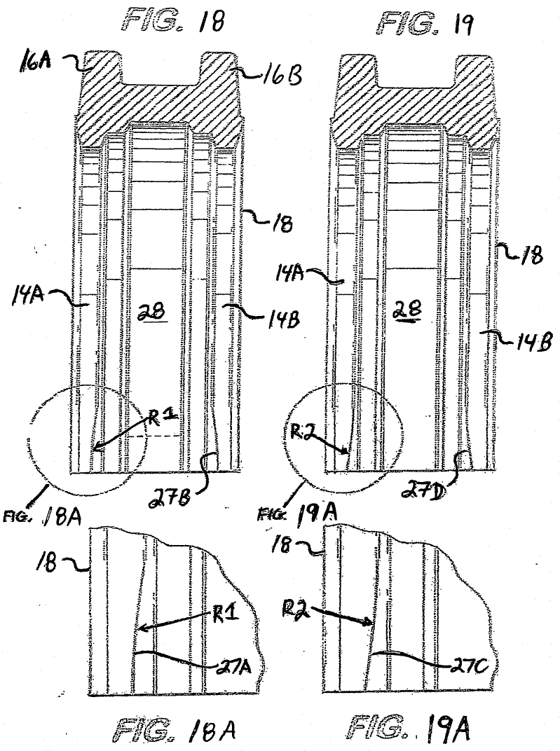

FIG. 17 shows the front view of a complete coupling 20 consisting of two coupling segments 18 and 19 and attachment hinge 68. The coupling segments 18 and 19 are supported by a lifting sling 69. An attachment hinge 68 is attached to anchoring points 70 on bolt pads 22A and 23A. Lifting the two coupling segments 18 and 19 from the lifting lugs 86A and 87B which are closest to the hinged side will spread the two coupling segments enough that they can be lowered over a component 1 with or without stiffening rings. The coupling segments are placed over the component with the camming surfaces engaging the circumferential key grooves on the component. The bolts and nuts are tightened until the keys fully engage the circumferential key grooves on the component.

FIG. 18 shows each camming surface is defined by a thinning of the key on which it is positioned. The thinning may be effected in various ways as depicted in FIGS. 18-22. As shown in FIGS. 18 and 18A, the camming surfaces are created on the inside faces of the keys 14A and 14B by curved surfaces 27A and 27B having radii R1. Surfaces 27A and 27B are concave relative to the surfaces of the keys 14A and 14B.

In an alternate configuration, shown in FIGS. 19 and 19A, camming surfaces 27C and 27D having convexly curved surfaces having respective radii R2.

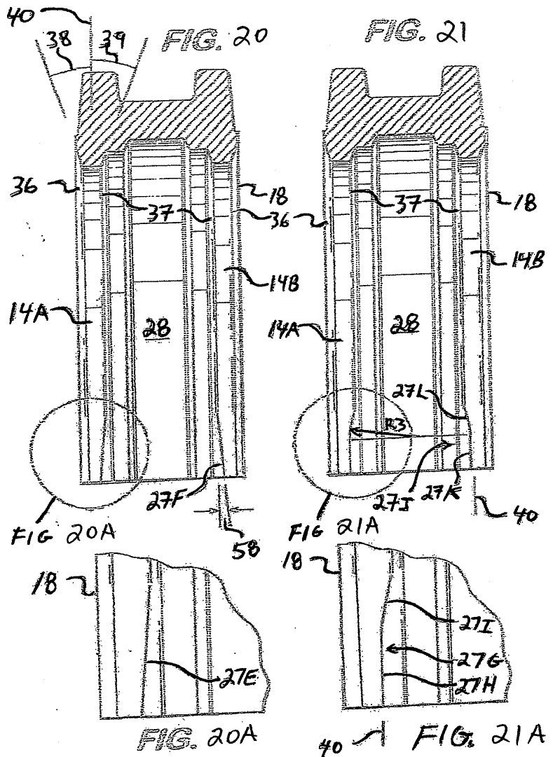

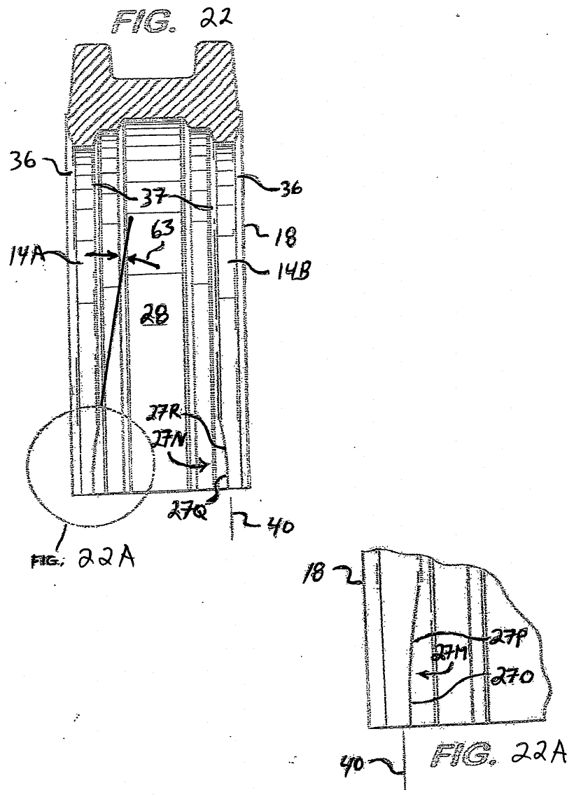

FIGS. 20 and 20A illustrate coupling 18 wherein each of the keys 14A and 14B form a pair of oppositely disposed key surfaces 36 and 37. The same is true of coupling segment nineteen. Key surfaces 36 and 37 are angularly oriented at respective orientation angles 38 and 39 relative to an imaginary reference plane 40 which passes through the coupling segments. Orientation angles 38 and 39 may range between about 0° and about 45° to the plane 40. The camming surfaces 27E and 27F are substantially flat surfaces which are angularly oriented with respect to the key surface on which they are positioned. The camming surfaces 27E and 27F have an orientation angle 58 between about 2° and about 20° relatively to the respective key surfaces 37 on which each camming surface is positioned.

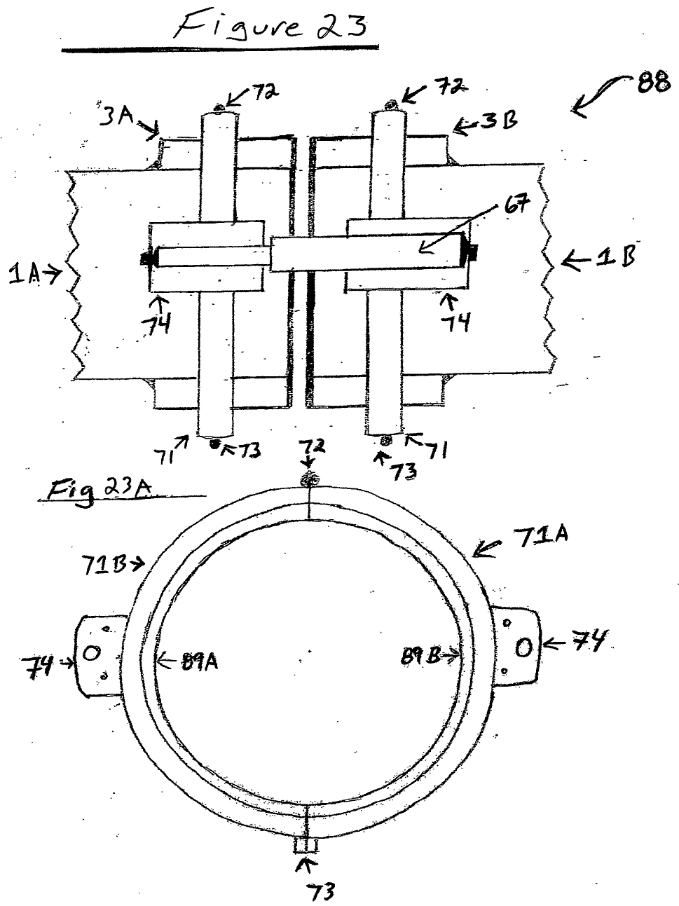

FIGS. 21 and 21A, each camming surface is formed of two surface portions. Camming surface 27G and 27J is formed of a flat surface portion 27H and 27K and a concavely curved surface portion 27I and 27L. The flat surface portions 27H and 27K is substantially parallel to the reference planes 40 and offset from the key surfaces 37. The curved surface portions 27I and 27L have respective radii R3. The curved surface portions 27I and 27L provide a smooth transition between the flat surface portions 27H and 27K and the surfaces 37 of the keys 14A and 14B.

In FIGS. 22 and 22A, each camming surface 27M and 27N is formed of two surface portions. Camming surface 27M and 27N is formed from a flat surface portion 27O and 27Q and an angularly oriented surface portion 27P and 27R. The flat surface portions 27O and 27Q are substantially parallel to the reference plane 40 and offset from the key surfaces 37. The angularly oriented surface portions 27P and 27R have an orientation angle 63 relatively to surfaces 37 of the keys 14A and 14B. Orientation angles between about 2° to about 45° are feasible. The angularly oriented surface portion 27P and 27R provide a smooth transition between the flat offset surface portions 27O and 27Q and the surfaces of the keys 14A and 14B.

One camming surface on a particular key need not be the same length, have the same offset, orientation angle or have the same curvature as its opposite camming surface on the other key. Additionally, the camming surfaces at opposite ends of a segment or in the middle of the coupling need not be the same as one another.

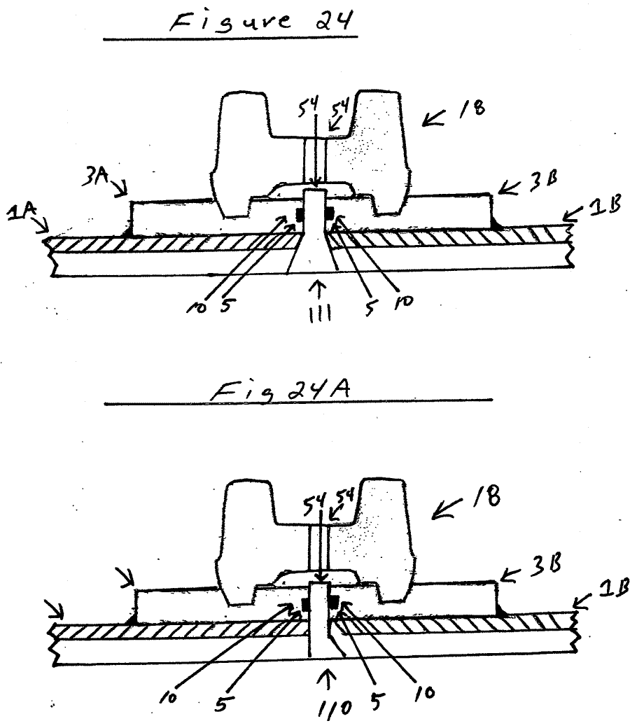

FIG. 23 is a side view of two components 1A and 1B such as pipe elements with stiffening rings 3A and 3B attached to the ends of the components 1A and 1B. An attachment 88 consisting of a minimum of two segments and having a minimum of one key is fitted and clamped over the stiffening rings having a key groove. The segment key is received by the circumferential key groove on the stiffening ring. Each attachment 88 segment is fitted with a hinge 72 and a connector 73. Each attachment segment has a minimum of one attachment point 74 to accommodate the fitment of various devices such as extension and contraction devices. A two way rams is shown in FIG. 23. FIG. 23 shows two attachments 88 joined together with a two way ram 67. When a two way ram connects two attachments together, the components 1A and 1B such as pipe elements can be pulled together or pushed apart. The attachment allows for angular articulation enabling the two attachments to be connected together regardless of the misalignment of the two components such as pipe elements. The attachment can also be used to install and remove protective inserts.

FIG. 23A is a front view of one attachment consisting of two segments 71A and 71B each with a key 89A and 89B, a hinge 72, a connector 73 and one attachment point 74 on each segment.

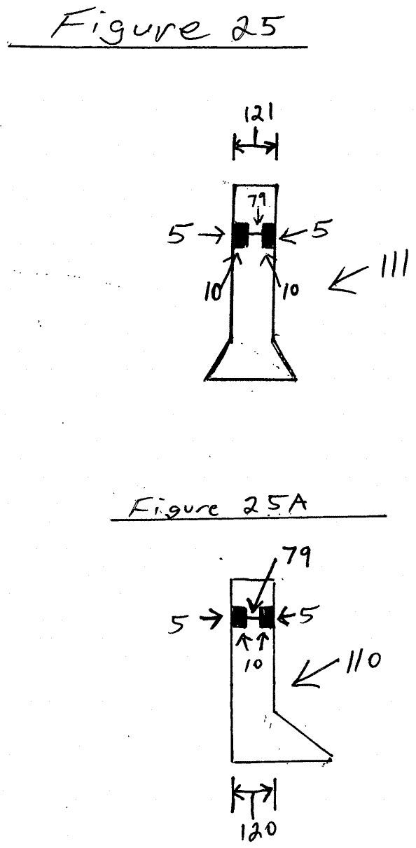

FIG. 24 is a partial cutaway side view of the top of the advanced coupling system in end to end configuration consisting of a coupling segment 18, stiffening rings 3A and 3B and a liner/coating anchor 111. The two stiffening rings 3A and 3B are attached to components 1A and 1B such as pipe elements. Coupling 18 is fitted with a thread hole 54 which extends completely through the coupling. Grooves 10 are fitted on the faces of stiffening rings 3A and 3B which receive sealing elements 5. A liner/coating anchor 111 is positioned between the faces of the stiffening rings 3A and 3B. The liner/coating anchor 111 can also be fitted between flanged connections. The liner/coating anchor must be firm enough to energize the sealing elements 5. The liner/coating anchor is fitted with a threaded hole 54 which partially extends into the liner/coating anchor 111 and will accommodate a monitoring device 53. The liner/coating anchor assists in holding the liner or coating on both sides of the joint against the inside surface of the component such as a piping element. A threaded hole 54 extends completely through the coupling 18.

FIG. 24A is a partial cutaway side view of the top of the advanced coupling system in end to end configuration consisting of a coupling segment 18, stiffening rings 3A and 3B and a liner/coating anchor 110. Stiffening rings 3A and 3B are attached to components 1A and 1B such as pipe elements. Grooves 10 are fitted on the faces of stiffening rings 3A and 3B which receive sealing elements 5. A liner/coating anchor 110 is positioned between the faces of the stiffening rings 3A and 3B. The liner/coating anchor 110 can also be fitted between flanged connections. The liner/coating anchor 110 must be firm enough to energize the sealing elements 5. The liner/coating anchor is fitted with a threaded hole 54 which partially extends into the liner/coating anchor 110 and will accommodate a monitoring device 53. The liner/coating anchor assists in holding the liner or coating against the inside surface of the component such as a piping element downstream from the joint. A threaded hole 54 extends completely through the coupling 18.

FIG. 25 is a partial cutaway side view of the top of the liner/coating anchor 111 with grooves 10 on each face which receives sealing elements 5 which are mechanically anchored with pins and holes 79. This liner/coating anchor is fitted between two components such as piping elements or between flanged connections and creates the seal and provides a near zero gap joints. The liner/coating anchor width 111 varies. This version of the liner/coating anchor assists in holding the liner or coating on both sides of the joint against the inside surface of the component such as a piping element.

FIG. 25A is a partial cutaway side view of the top of the liner/coating anchor 110 with grooves 10 on each face which receive sealing elements 5 which are mechanically anchored with pins and holes 79. This liner/coating anchor is fitted between two components such as piping elements or between flanged connections and create the seal and provide a near zero gap joints. The liner/coating anchor width 110 varies. The liner/coating anchor assists in holding the liner or coating against the inside surface of the component such as a piping element downstream from the joint.

Monitoring devices can be permanently installed or temporarily installed.

1. An advanced coupling system that mechanically joins components such as pipe elements in end to end configuration, the advanced coupling system comprising: a minimum of two coupling segments and two stiffening rings, said stiffening rings having circumferential key grooves proximate to an end thereof, each coupling segment having a pair of keys projecting radially inwardly, said keys being positioned in spaced apart relation from one another and defining a space there between and having key surface angles ranging from 0° to 45° relative to said plane, large diameter coupling segments having a pair of stiffening ribs projecting radially outwardly away therefrom and said stiffening ribs are substantially aligned with said coupling segment keys, said stiffening ribs being positioned in spaced apart relation to one another, each said coupling segment key for engagement with said circumferential key groove on stiffening rings, key grooves having key surface angles ranging from 0° to 45° relative to said plane, coupling segment keys are forcibly engaged circumferentially around key grooves on stiffening rings, said key grooves receive the keys on the coupling segments when the coupling segments are fitted around the stiffening rings, stiffening rings are attached to components being joined in end to end configuration and are fitted with a minimum of one groove positioned on the face of the stiffening ring facing the joint which receives a sealing element which is mechanically anchored, said sealing elements provide the sealing and pressure containment.

2. The advanced coupling system according to claim 1, wherein stiffening rings attach to components such as piping elements by means of welding, friction welding, bonding, threading, bolting, casting or forging.

3. The advanced coupling system according to claim 1, wherein the stiffening rings are fitted with a groove on the face, said groove has sides, a depth and width, each groove side has an orientation angle of 0° to 50° relative to a reference plane and groove side angles are identical or different, depth and width dimensions vary to accommodate sealing elements of different sizes and shapes, each groove receives a minimum of one sealing element which are removable, replaceable and interchangeable, sealing elements consists of multiple sizes, shapes, hardness and materials, sealing elements of different shapes, sizes, materials and hardness can be attached together, said sealing element partially or completely fills a groove, said sealing element is energized by another sealing element or any surface rigid enough to adequately compress the sealing element, said sealing element is anchored by means of mechanical compression, pin and hole, adhesion or any combination thereof and whereby a minimum of one anchoring point positions said sealing element.

4. The advanced coupling system according to claim 1, wherein a gap no larger than 3/16 shall exist at the joint between the components being joined in end to end configuration with an ideal gap being 1/32 and smaller.

5. An advanced coupling system that mechanically joins components such as pipe elements in end to end configuration, the advanced coupling system comprising: a minimum of two coupling segments and a minimum of one stiffening ring, said stiffening ring having a circumferential key groove proximate to an end thereof, each coupling segment having a pair of keys projecting radially inwardly, each key being different, said keys having different shape or size or key angles or any combination thereof, said keys being positioned in spaced apart relation from one another and defining a space there between and having key surface angles ranging from 0° to 45° relative to said plane, large diameter coupling segments having a pair of stiffening ribs projecting radially outwardly away therefrom and said stiffening ribs are substantially aligned with said coupling segment keys, said stiffening ribs being positioned in spaced apart relation to one another, each said coupling segment key for engagement with said circumferential key groove on stiffening rings, components or any combination thereof, key grooves having key surface angles ranging from 0° to 45° relative to said plane, coupling segment keys are forcibly engaged circumferentially around key grooves, said key grooves receive the keys on the coupling segments when the coupling segments are fitted around the stiffening rings, components or any combination thereof, said stiffening ring is attached to a component being joined in end to end configuration and is fitted with a minimum of one groove positioned on the face of the stiffening ring facing the joint which receives a sealing element which is mechanically anchored, said sealing element provides the sealing and pressure containment.

6. The advanced coupling system according to claim 5, wherein stiffening rings attach to components such as piping elements by means of welding, friction welding, bonding, threading, bolting, casting or forging.

7. The advanced coupling system according to claim 5, wherein the stiffening rings are fitted with a groove on the face, said groove has sides, a depth and width, each groove side has an orientation angle of 0° to 50° relative to a reference plane and groove side angles are identical or different, depth and width dimensions vary to accommodate sealing elements of different sizes and shapes, each groove receives a minimum of one sealing element which are removable, replaceable and interchangeable, sealing elements consists of multiple sizes, shapes, hardness and materials, sealing elements of different shapes, sizes, materials and hardness can be attached together, said sealing element partially or completely fills a groove, said sealing element is energized by another sealing element or any surface rigid enough to adequately compress the sealing element, said sealing element is anchored by means of mechanical compression, pin and hole, adhesion or any combination thereof and whereby a minimum of one anchoring point positions said sealing element.

8. The advanced coupling system according to claim 5, wherein a gap no larger than 3/16 shall exist at the joint between the components being joined in end to end configuration with an ideal gap being 1/32 and smaller.

9. The advanced coupling system according to claim 5, wherein a coupling segment consisting of two keys which are different, said keys having different shape or size or key angles or any combination thereof, key surface angles range from 0° to 45° relative to said plane, said coupling keys having sizes, shapes and angles compatible with any circumferential groove receiving said coupling key.

10. The advanced coupling system according to claim 5, wherein the coupling segment keys offer several different camming surfaces that are identical or different and narrow said keys by as much as 85% on the inside faces of one or both keys at one or both ends and or in the middle of a coupling segment or any combination thereof having the same or different lengths of camming surfaces that occupy between 2.5% to 30% of the total arc length of said coupling key, camming surfaces guide the coupling keys into key grooves when said coupling segments are forcibly engaged circumferentially around key grooves.

11. The advanced coupling system according to claim 10, wherein the camming surfaces are created with concaved or convexly curved surfaces relative to the surface of the keys.

12. The advanced coupling system according to claim 10, wherein the camming surfaces have an orientation angle between about 2° to about 20° relative to the respective key surfaces on which each camming surface is positioned.

13. The advanced coupling system according to claim 10, wherein the camming surface is formed of a flat surface portion and a concavely curved surface portion, the flat surface portions are substantially parallel to reference plans and offset from the inside key surfaces, the curved surface portions provide a smooth transition between the flat surface portions and the surfaces of the keys.

14. The advanced coupling system according to claim 10, wherein the camming surface is formed of a flat surface portion and an angularly oriented surface portion, the flat surface portions are substantially parallel to reference plans and offset from the inside key surfaces, the angularly oriented surface portions have an orientation angle relatively to the surfaces of the keys of 2° to about 45° are feasible, the angularly orientated surface portions provide a smooth transition between the flat, offset portions and the surfaces of the keys.

15. The advanced coupling system according to claim 5, wherein the coupling segment keys having different shape or size or key angles or any combination thereof will join any combination of components with or without a stiffening ring regardless of key groove size, shape, dimensions and groove angles.

16. An advanced coupling system that mechanically joins components such as pipe elements in end to end configuration and capable of monitoring the components being joined in end to end configuration, the advanced coupling system comprising: a minimum of two coupling segments and a minimum of one stiffening ring, said stiffening ring having a circumferential key groove proximate to an end thereof, each coupling segment having a pair of keys projecting radially inwardly, said keys being positioned in spaced apart relation from one another and defining a space there between, each said coupling segment key for engagement with said circumferential key groove on stiffening rings, components or any combination thereof, said key angles and key groove angles ranging from 0° to 45°, coupling segment keys are forcibly engaged circumferentially around key grooves, said key grooves receive the keys on the coupling segments, a minimum of one thread hole facilitates the monitoring of components such as coupling segments, stiffening rings, piping elements and accessories being joined in end to end configuration.

17. The advanced coupling system according to claim 16, wherein a minimum of one threaded hole is fitted to components such as coupling segments, stiffening rings, piping elements and accessories which are fitted with monitoring devices and bulk head connectors/wire feedthroughs for the purpose of monitor wear, erosion and corrosion of components, a threaded hole that extends from the outside diameter to the inside diameter of one or more components with or without liners/coatings and accesses the pressure retaining space of a component is fitted with a bulk head connector/wire feedthrough, said components receiving a threaded hole which only partially extends into a component from the outside diameter is fitted with a monitoring device, the threaded holes facilitate permanent or temporary fitment of monitoring devices and bulk head connectors/wire feedthroughs and when permanently installed pressure containment is achieved.

18. An advanced coupling system that mechanically joins components such as pipe elements with or without liners/coatings in end to end configuration with accessories fitted between the faces of the components being joined in end to end configuration, the advanced coupling system comprising: a minimum of two coupling segments and a minimum of one accessory fitted between the components being joined in end to end configuration, each coupling segment having a pair of keys projecting radially inwardly, said keys being positioned in spaced apart relation from one another and defining a space there between, having key surface angles ranging from 0° to 45° relative to said plane, each said coupling segment key for engagement with said circumferential key groove, key grooves having key surface angles ranging from 0° to 45° relative to said plane, coupling segment keys are forcibly engaged circumferentially around key grooves, said key grooves receive the keys on the coupling segments.

19. The advanced coupling system according to claim 18, wherein accessories include protective inserts and liner/coating anchors consisting of metallic, non-metallic or a combination of said materials.

20. The advanced coupling system according to claim 19, wherein protective inserts and liner/coating anchors are fitted between two advanced coupling system stiffening rings or between one advanced coupling system stiffening ring and one stiffening ring of a different make and model or between components such as pipe elements, elbows, tees, crosses, Y bends, fittings, hoses, expansion joints, vessels, valves, tubes, flanges, tanks, filters, strainers, pumps, heat exchangers, reducers, steam traps, steam separators, instrumentation components or any combination thereof with one or no stiffening rings or between flanged connections, said protective inserts and liner/coating anchors are fitted with or without holes on the faces or circumferential notches, said protective insert and liner/coating anchors vary in width and when fitted with one or more sealing elements create the seal between two components or flanged connections, regardless of configuration there shall be a gap no larger than 3/16 at any joint with an ideal gap being 1/32 and smaller.

21. The advanced coupling system according to claim 19, wherein protective inserts consist of a ring or a ring and a re-enforced sub-straight ring, both versions of the protective inserts are lined/coated with a non-metallic or metallic material or any combination thereof, the protective insert with no re-enforced sub-straight ring has a liner/coating with an outside diameter the same or slightly smaller than the inside diameter of a component it is protecting, the re-enforced sub-straight ring has a smaller outside diameter than the inside diameter of the component it is protecting and is fitted with a minimum of one sealing element on the outside diameter of the re-enforced sub-straight ring or the sealing element is part of the liner/coating and both versions provide a snug fit between the protective insert re-enforced sub-straight ring and the inside diameter of the component it is protecting, said liners/coatings are bonded or mechanically anchored or any combination thereof to the protective inserts, said non-metallic materials come with or without one or more monitoring devices imbedded into the non-metallic material at different depths and positioned anywhere circumferentially.

22. An advanced coupling system attachments assist with the connecting and disconnecting of components being joined together in end to end configuration, the advanced coupling system attachments comprising: a minimum of two segments, each segment having a minimum of one key projecting radially inwardly, each said segment key for engagement with said circumferential key groove on components being connected or disconnected, the segment key is forcibly engaged circumferentially around key groove, said key groove receives the key on the segments, and segments are joined together with a hinge.

23. The advanced coupling system according to claim 23, wherein an attachment consisting of a minimum of two segments, a hinge, a connector and a key, said key projects radially inwardly, said segments are fitted over a component with or without stiffening ring having a key groove, said key being forcibly engaged circumferentially around a key groove, said key groove receives the key on the segment, said connector locks the segments tightly around the component having key groove, said attachment segments have a minimum of one attachment point to accommodate the fitment of an expansion contraction device, said attachment points allow articulation, said attachment can be fitted to all groove sizes, shapes or angles.

24. The advanced coupling system according to claim 23, wherein an attachment hinge is fitted to the bolt pads of two coupling segments and when said segments are suspended by a lifting sling connected to the lifting lugs closest to the attachment hinge the coupling segments will spread open enough to be dropped down over a component such as a pipe element without making contact with said component.
